(19) United States
(12) Patent Application Publication
(10) Pub. No.: US 2026/0326346 A1
(43) Pub. Date: Oct. 22, 2026

(54) SURFACE STRUCTURE AND MOLD

(71) Applicant: WNC Corporation, Hsinchu (TW)

(72) Inventors: Yi Chun JIN, Hsinchu (TW); Feng-Ming CHANG, Hsinchu (TW); Bau-Yi HUANG, Hsinchu (TW); Han-Chang PAN, Hsinchu (TW); Liang-Jiun CHEN, Hsinchu (TW)

(21) Appl. No.: 19/424,382

(22) Filed: Dec. 18, 2025

(30) Foreign Application Priority Data
Apr. 16, 2025 (TW) 114114392

(51) Int. Cl. B29C 33/42

(52) U.S. Cl. CPC B29C 33/424

(57) ABSTRACT

A surface structure includes a primary structure. The primary structure includes a plurality of protruded portions, and the protruded portions are located on a side of the primary structure. The protruded portions are arranged apart from each other, wherein each of the protruded portions has a protruded width, and the protruded width is between 50 µm to 500 µm.

### RELATED APPLICATIONS

This application claims the benefit of priority to Taiwan Patent Application No. 114114392, filed on Apr. 16, 2025. The entire content of the above identified application is incorporated herein by reference.

### BACKGROUND

### Technical Field

The present disclosure relates to a surface structure and a mold, in particular to a surface structure and a mold having a self-cleaning function and eliminating secondary processing.

### Description of Related Art

When outdoor products are exposed outdoors for a long period of time, water stains and dirt are often retained on the product surface, thereby affecting the appearance of the product. A conventional treatment method is to spray a hydrophobic coating on the product surface, but this method requires secondary processing, and the coating has a time limitation and is easily degraded by environmental factors.

Furthermore, although the conventional coating can keep the product surface clean, it is limited by its lifetime and needs to be reapplied periodically, resulting in high maintenance costs.

In view of the above, the development of a surface structure having a self-cleaning function and eliminating secondary processing has become the goal pursued by related industries.

### SUMMARY

One aspect of the present disclosure is to provide a surface structure including a primary structure. The primary structure includes a plurality of protruded portions located on one side of the primary structure and arranged apart from each other, wherein each protruded portion has a protruded width ranging from 50 µm to 500 µm.

Another aspect of the present disclosure is to provide a mold for manufacturing the aforesaid surface structure. The mold has a plurality of grooves arranged apart from each other, each groove having a groove width ranging from 50 µm to 500 µm.

### BRIEF DESCRIPTION OF THE DRAWINGS

The present disclosure can be more fully understood by reading the following detailed description of the embodiment, with reference made to the accompanying drawings as follows:

FIG. 1 is a sectional schematic view of a surface structure according to a first embodiment of the present disclosure.

FIG. 2A is a top schematic view of the surface structure of FIG. 1.

FIG. 2B is an enlarged schematic view of region 2B in FIG. 2A.

FIG. 3A is a top schematic view of a surface structure according to a second embodiment.

FIG. 3B is an enlarged schematic view of region 3B in FIG. 3A.

FIG. 4A is a top schematic view of a surface structure according to a third embodiment.

FIG. 4B is an enlarged schematic view of region 4B in FIG. 4A.

FIG. 5 is a sectional schematic view of a surface structure according to a fourth embodiment.

FIG. 6A is a top schematic view of a surface structure according to a fifth embodiment.

FIG. 6B is an enlarged schematic view of region 6B in FIG. 6A.

FIG. 7 is a top schematic view of a surface structure according to a sixth embodiment.

FIG. 8 is a perspective schematic view of a surface structure applied to a product according to a seventh embodiment.

FIG. 9 is a perspective schematic view of a mold according to an eighth embodiment.

FIG. 10 shows experimental results of protruded depth versus contact angle for the first, second and third embodiments.

FIG. 11 shows experimental results of surface roughness versus contact angle for the fourth embodiment.

FIG. 12 shows experimental results of dimensional ratio versus contact angle for the first embodiment.

FIG. 13 shows experimental results of protruded depth, surface roughness, and contact angle for the fifth and sixth embodiments.

FIG. 14A is a microscope image of the first embodiment.

FIG. 14B is another microscope image of the first embodiment.

FIG. 15A is a microscope image of the second embodiment.

FIG. 15B is another microscope image of the second embodiment.

FIG. 16A is a microscope image of the third embodiment.

FIG. 16B is another microscope image of the third embodiment.

FIG. 17A is a microscope image of the fifth embodiment.

FIG. 17B is another microscope image of the fifth embodiment.

FIG. 17C is yet another microscope image of the fifth embodiment.

FIG. 17D is still another microscope image of the fifth embodiment.

FIG. 18A is a microscope image of the sixth embodiment.

FIG. 18B is another microscope image of the sixth embodiment.

FIG. 18C is yet another microscope image of the sixth embodiment.

FIG. 18D is still another microscope image of the sixth embodiment.

FIG. 19 shows experimental results of material versus contact angle of the surface structure.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

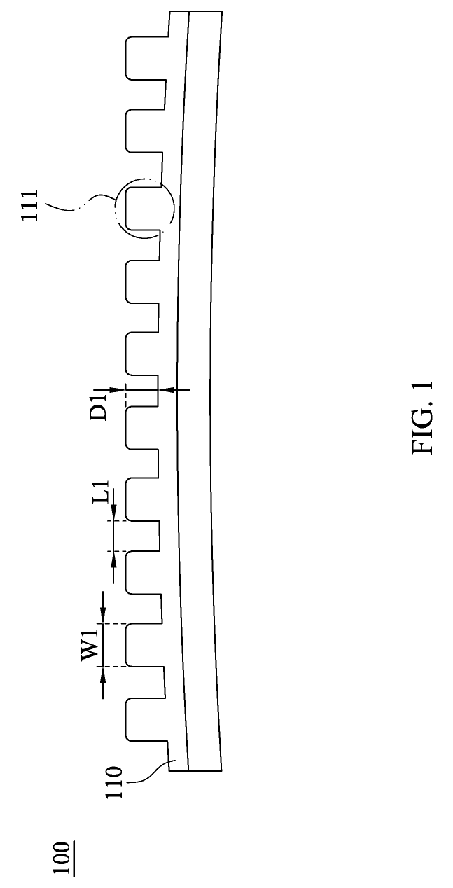

Referring to FIG. 1, which illustrates a sectional schematic view of a surface structure 100 according to a first embodiment of the present disclosure. The surface structure 100 includes a primary structure 110. The primary structure 110 includes a plurality of protruded portions 111. The protruded portions 111 are located on one side of the primary structure 110 and are arranged apart from each other, wherein each protruded portion 111 has a protruded width W1 ranging from 50 µm to 500 µm.

By providing the protruded portions 111 and selecting a specific size of the protruded width W1, the hydrophobicity of the surface structure 100 can be improved, and the surface structure 100 can achieve a self-cleaning function. When liquid drops onto the surface structure 100, the liquid is not easily attached to the surface structure 100, and dirt attached to the surface structure 100 can be carried away as the liquid slides off the surface structure 100.

Specifically, a material of the surface structure 100 may be selected from a group consisting of polycarbonate (PC), polyoxymethylene (POM), acrylonitrile styrene acrylate (ASA), acrylonitrile butadiene styrene (ABS), polybutylene terephthalate (PBT), polymethyl methacrylate (PMMA), and polysiloxane, but is not limited thereto.

Furthermore, the material of the surface structure 100 may be PC, POM, ASA, ABS, PBT, PMMA, a mixture of PC and polysiloxane, a mixture of PC and ABS, or a mixture of PC and ASA, but is not limited thereto.

A cross-sectional shape 112 of the protruded portion 111 may be circular, hexagonal, droplet-shaped, rectangular, or a combination thereof. Accordingly, different cross-sectional shapes 112 can be arbitrarily combined according to the environmental requirements where the surface structure 100 is applied, so as to obtain favorable self-cleaning effects.

The protruded portion 111 may have a protruded depth D1, and the protruded depth D1 may be greater than or equal to 15 µm. By providing a specific protruded depth D1, the hydrophobicity of the surface structure 100 can be enhanced, and the self-cleaning performance can be further improved.

Furthermore, the protruded depth D1 may range from 25 µm to 50 µm. Selecting the protruded depth D1 within this specific range allows the surface structure 100 to exhibit higher hydrophobicity, and the self-cleaning performance can be further improved.

Further, the protruded depths D1 of the protruded portions 111 may be different from one another. Accordingly, liquid droplets on the surface structure 100 may exhibit a tendency of directional movement, causing the droplets to flow in a specific direction and thereby enhancing hydrophobicity and droplet flow efficiency.

An interval length L1 is provided between any two adjacent protruded portions 111, and the interval length L1 may be greater than or equal to 100 µm. Accordingly, the hydrophobicity of the surface structure 100 can be improved, and the self-cleaning performance can be further enhanced.

Furthermore, the interval lengths L1 between the protruded portions 111 may be unequal to each other. This allows the liquid droplets on the surface structure 100 to have a tendency of directional movement and achieve a guiding-flow effect.

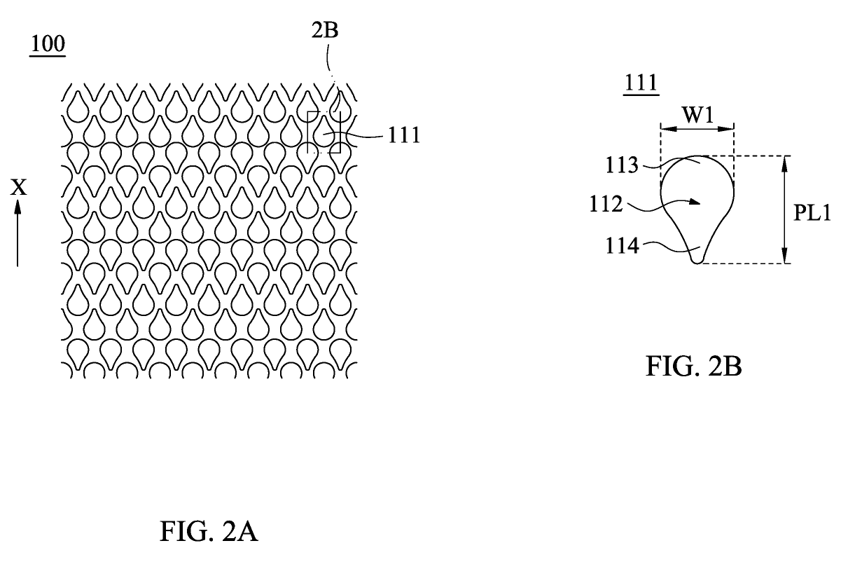

Please also refer to FIGS. 1, 2A, and 2B. FIG. 2A is a top schematic view of the surface structure 100 shown in FIG. 1. FIG. 2B is an enlarged schematic view of region 2B in FIG. 2A.

The cross-sectional shape 112 of the protruded portion 111 may be droplet-shaped. Each protruded portion 111 may have a protruded length PL1 ranging from 120 µm to 370 µm, and a protruded width W1 ranging from 150 µm to 310 µm.

Specifically, the protruded portions 111 may be arranged in a staggered manner. In other words, along an arrangement direction X, the protruded portions 111 of one row may partially extend into the gaps of the protruded portions 111 of the next row. Accordingly, a denser arrangement structure can be obtained to adjust the hydrophobic characteristics of the surface structure 100.

Further, each protruded portion 111 may have a blunt end 113 and a pointed end 114. Along the arrangement direction X, the blunt end 113 of each protruded portion 111 may be disposed opposite to the blunt end 113 of one adjacent protruded portion 111, and the pointed end 114 of each protruded portion 111 may be disposed opposite to the pointed end 114 of another adjacent protruded portion 111. Alternatively, the blunt end 113 and the pointed end 114 of each protruded portion 111 may be respectively disposed opposite to the blunt ends 113 of two adjacent protruded portions 111, or opposite to the pointed ends 114 of two adjacent protruded portions 111. By controlling the orientation of the blunt ends 113 and pointed ends 114, the mobility of liquid droplets on the surface structure 100 can be enhanced.

Furthermore, the ratio of the protruded width W1 to the protruded length PL1 may range from 1:1 to 1:6. By selecting a specific ratio of the protruded width W1 to the protruded length PL1, the liquid-guiding effect of the surface structure 100 can be enhanced, thereby providing the surface structure 100 with improved hydrophobic performance.

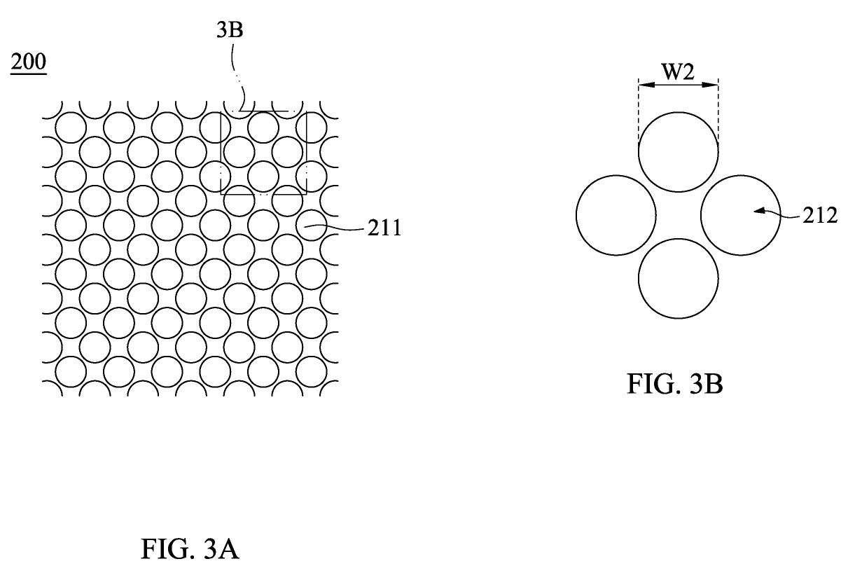

Referring to FIGS. 3A and 3B, FIG. 3A illustrates a top schematic view of a surface structure 200 according to a second embodiment, and FIG. 3B illustrates an enlarged schematic view of region 3B in FIG. 3A. The cross-sectional shape 212 of the protruded portion 211 may be circular, and the protruded width W2 may range from 120 µm to 350 µm. Controlling the cross-sectional shape 212 to be circular is advantageous in reducing the complexity of manufacturing the surface structure 200.

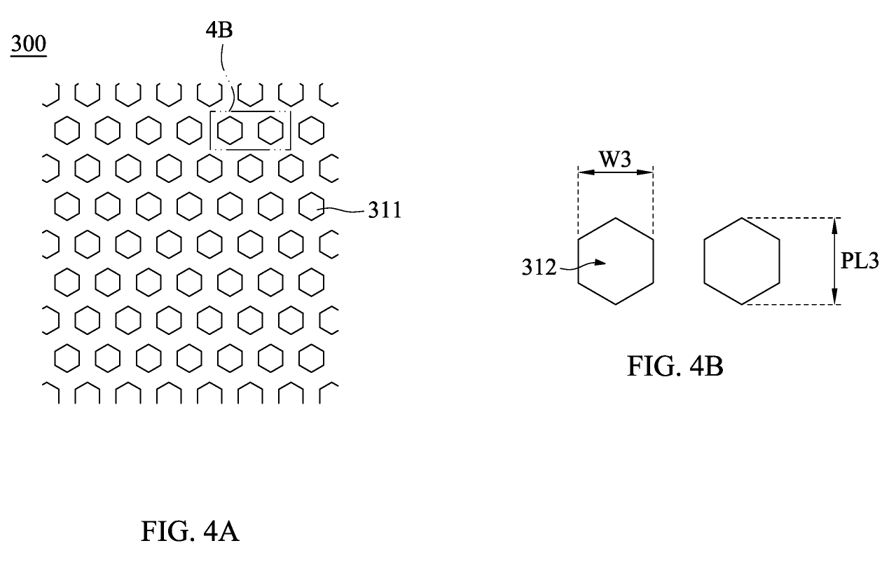

Referring to FIGS. 4A and 4B, FIG. 4A illustrates a top schematic view of a surface structure 300 according to a third embodiment, and FIG. 4B illustrates an enlarged schematic view of region 4B in FIG. 4A. The cross-sectional shape 312 of the protruded portion 311 may be hexagonal. Each protruded portion 311 may have a protruded length PL3 ranging from 110 µm to 270 µm and a protruded width W3 ranging from 140 µm to 240 µm. By controlling the cross-sectional shape 312 to be hexagonal, the hydrophobicity of the surface structure 300 can be further improved to enhance the self-cleaning effect.

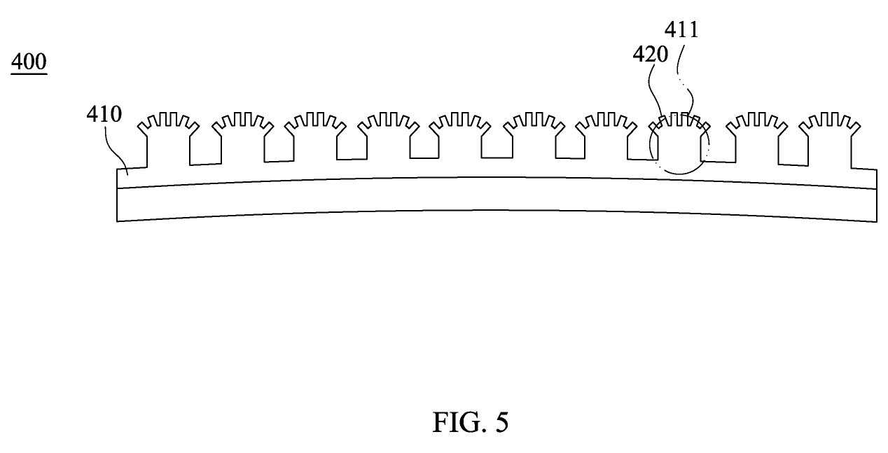

Referring to FIG. 5, FIG. 5 illustrates a sectional schematic view of a surface structure 400 according to a fourth embodiment. The configuration relationship of the primary structure 410 in FIG. 5 is similar to that of the primary structure 110 in FIG. 1, and the similarities will not be further described herein.

It is noteworthy that the surface structure 400 may further include a plurality of secondary structure layers 420. The secondary structure layers 420 may be respectively disposed on one side of each protruded portion 411, and the surface roughness of each secondary structure layer 420 may be less than or equal to 50 µm.

By providing the secondary structure layers 420, the rolling ability of water droplets on the surface can be enhanced, thereby improving the hydrophobicity of the surface structure 400 and further enhancing the self-cleaning performance. Furthermore, the secondary structure layers 420 may have a specific surface roughness, enabling the surface structure 400 to achieve higher hydrophobicity and favorable self-cleaning effects.

Further, the surface roughness of the secondary structure layers 420 may range from 0.5 µm to 5.0 µm. In this way, the hydrophobicity of the surface structure 400 can be improved, and the self-cleaning performance can be further enhanced.

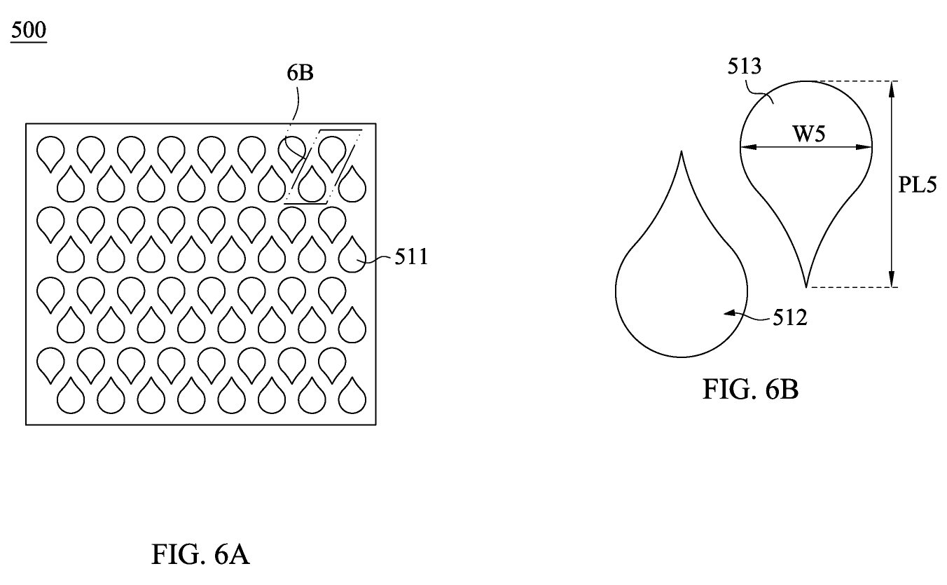

Referring to FIGS. 6A and 6B, FIG. 6A illustrates a top schematic view of a surface structure 500 according to a fifth embodiment, and FIG. 6B illustrates an enlarged schematic view of region 6B in FIG. 6A. The ratio of the protruded width W5 to the protruded length PL5 of the protruded portion 511 may range from 1:1 to 1:6. Furthermore, the ratio of the protruded width W5 to the protruded length PL5 of the protruded portion 511 may be 1:1.5.

The cross-sectional shape 512 of each protruded portion 511 is droplet-shaped, and the blunt end 513 of each protruded portion 511 is arc-shaped.

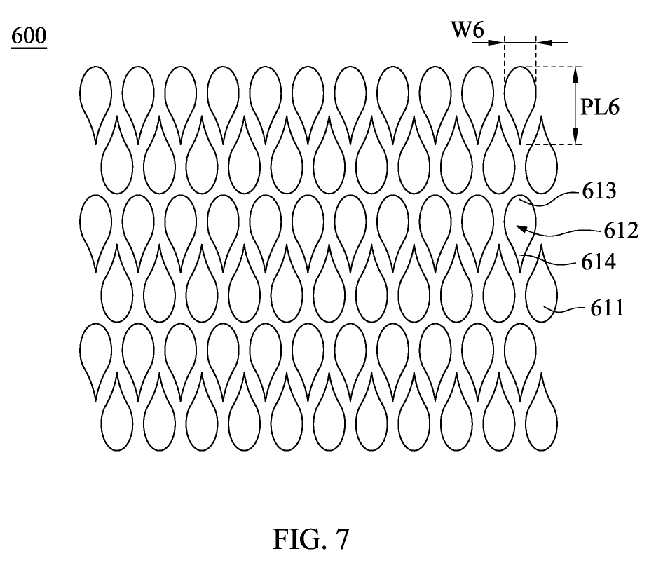

Referring to FIG. 7, FIG. 7 illustrates a top schematic view of a surface structure 600 according to a sixth embodiment. In the surface structure 600 shown in FIG. 7, the blunt end 613 of each protruded portion 611 may be disposed opposite to the blunt end 613 of one adjacent protruded portion 611, and the pointed end 614 of each protruded portion 611 may be disposed opposite to the pointed end 614 of another adjacent protruded portion 611. The ratio of the protruded width W6 to the protruded length PL6 of the protruded portion 611 may range from 1:1 to 1:6. Furthermore, the ratio of the protruded width W6 to the protruded length PL6 of the protruded portion 611 may be 1:4.

The cross-sectional shape 612 of each protruded portion 611 is droplet-shaped, and the blunt end 613 of each protruded portion 611 is arc-shaped. Specifically, the cross-sectional shape 612 of the protruded portion 611 in the sixth embodiment is an elongated droplet shape. Accordingly, the surface structure 600 may provide a liquid-guiding effect, thereby giving the surface structure 600 improved hydrophobic performance.

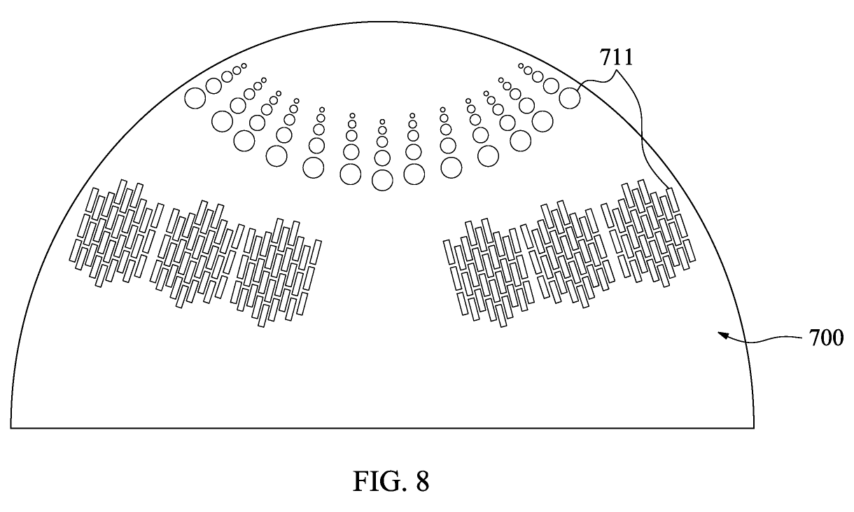

Referring to FIG. 8, FIG. 8 illustrates a perspective schematic view of a surface structure 700 applied to a product according to a seventh embodiment. The cross-sectional shapes (not labeled) of the protruded portions 711 in FIG. 8 include rectangular and circular shapes. When the surface structure 700 is applied to a spherical product, circular protruded portions 711 may be provided at the top of the product, and rectangular protruded portions 711 may be provided at the middle portion of the product, so as to provide different hydrophobic characteristics in different regions. However, the present disclosure is not limited thereto.

When the surface structure 700 is applied to a spherical product, liquid can more easily slide off, thereby increasing the hydrophobicity of the spherical product surface. Furthermore, when liquid drops onto the surface structure 700, dirt can be removed from the surface structure 700 as the liquid drips off, achieving a favorable self-cleaning effect.

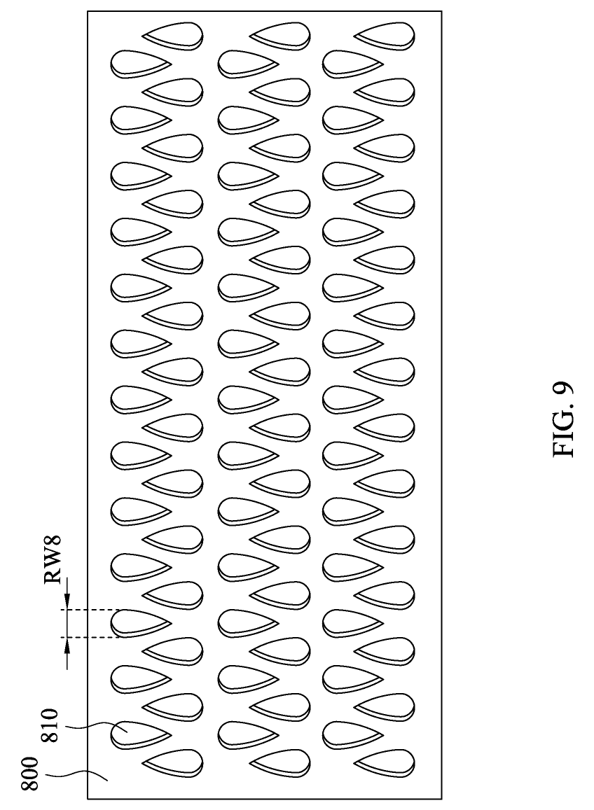

Referring to FIG. 9, FIG. 9 illustrates a perspective schematic view of a mold 800 according to an eighth embodiment. The mold 800 has a plurality of grooves 810 arranged apart from each other, each groove 810 having a groove width RW8 ranging from 50 µm to 500 µm. However, the present disclosure is not limited to the material and shape of the mold 800.

The following description relates to experimental results conducted for the foregoing embodiments.

### Experiment on Protruded Depth and Contact Angle

In this experiment, the first, second, and third embodiments were selected, and the protruded depth was set to 25 µm or 40 µm. Water droplets were dripped onto the surface structure to measure the contact angle. Each group of experiments was performed five times, and the median value was taken to obtain the contact angle. The influence of different cross-sectional shapes and different protruded depths on the contact angle was compared, wherein a larger contact angle indicates higher hydrophobicity.

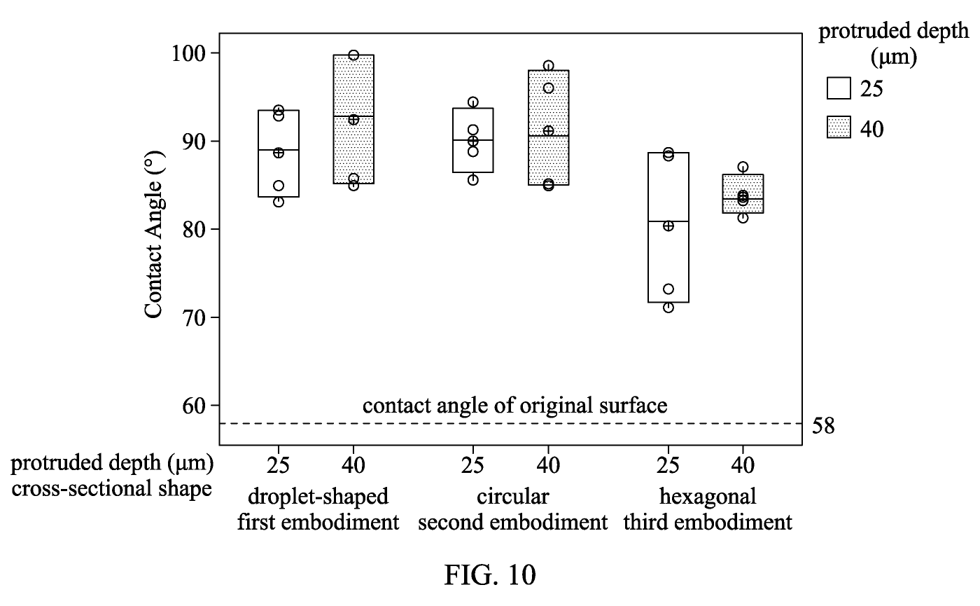

Referring to FIG. 10, FIG. 10 illustrates an experimental diagram of the protruded depth versus the contact angle of the first, second, and third embodiments. It is noteworthy that the contact angle of the original surface without the surface structure was 58°.

When the protruded depth of the first embodiment was set to 25 µm, the contact angle of its surface structure was 88.67°. When the protruded depth was set to 40 µm, the contact angle of its surface structure was 92.4975°.

When the protruded depth of the second embodiment was set to 25 µm, the contact angle of its surface structure was 90.0425°. When the protruded depth was set to 40 µm, the contact angle of its surface structure was 91.1725°.

When the protruded depth of the third embodiment was set to 25 µm, the contact angle of its surface structure was 80.35°. When the protruded depth was set to 40 µm, the contact angle of its surface structure was 83.7825°.

From this experiment, it can be concluded that the surface structure of the present disclosure indeed has a higher contact angle, which improves hydrophobicity, and that the hydrophobicity of the surface structure can be further enhanced by setting a specific protruded depth.

### Experiment on Surface Roughness and Contact Angle

In this experiment, the fourth embodiment was selected, and the surface roughness was set between 0.05 µm and 16 µm. Water droplets were dripped onto the surface structure to measure the contact angle.

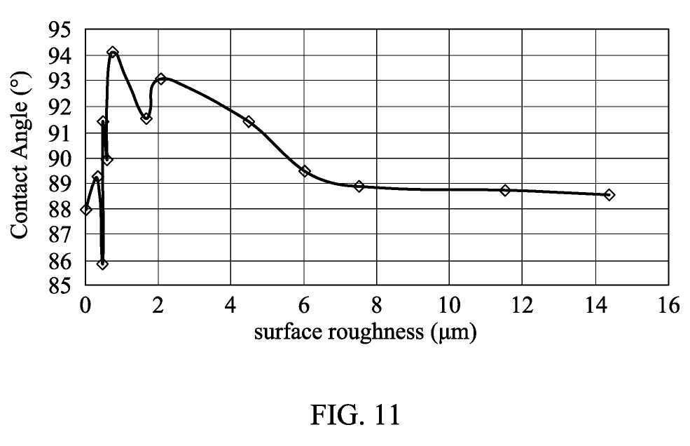

Referring to FIG. 11, FIG. 11 illustrates an experimental diagram of surface roughness versus contact angle for the fourth embodiment. From FIG. 11, it can be seen that the surface structure of the present disclosure can achieve a high contact angle, and when the surface roughness is between 0.5 µm and 5.0 µm, the surface structure exhibits a higher contact angle, that is, higher hydrophobic performance.

### Experiment on Dimensional Ratio and Contact Angle

In this experiment, the first embodiment was selected, and different ratios of protruded width to protruded length were set, namely 1:2, 1:3, 1:4, 2:3, 2:4, and 2:5. Water droplets were dripped onto the surface structure to measure the contact angle.

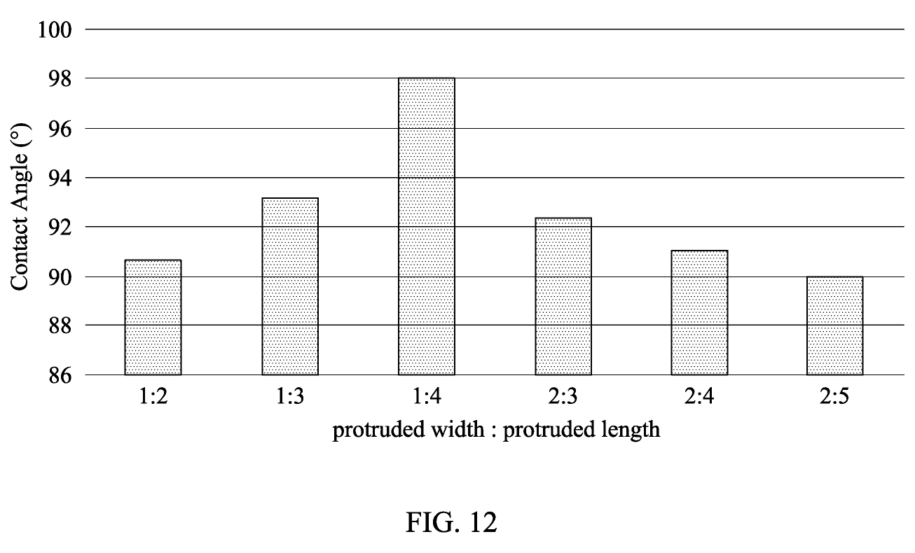

Referring to FIG. 12, FIG. 12 illustrates an experimental diagram of dimensional ratio versus contact angle for the first embodiment. From FIG. 12, it can be seen that the surface structure of the present disclosure exhibits a high contact angle at any ratio, and when the ratio of protruded width to protruded length is 1:3, 1:4, or 2:3, the surface structure has a larger contact angle and favorable hydrophobicity. Furthermore, when the ratio of protruded width to protruded length is 1:4, the surface structure has the largest contact angle of 98°, achieving the best hydrophobic property.

### Experiment on Protruded Depth, Surface Roughness, and Contact Angle

In this experiment, the fifth and sixth embodiments were selected. The surface roughness of the secondary structure layer was set to 0.05 µm or 1.6 µm, and the protruded depth was set to 25 µm or 40 µm. Water droplets were dripped onto the surface structure to measure the contact angle.

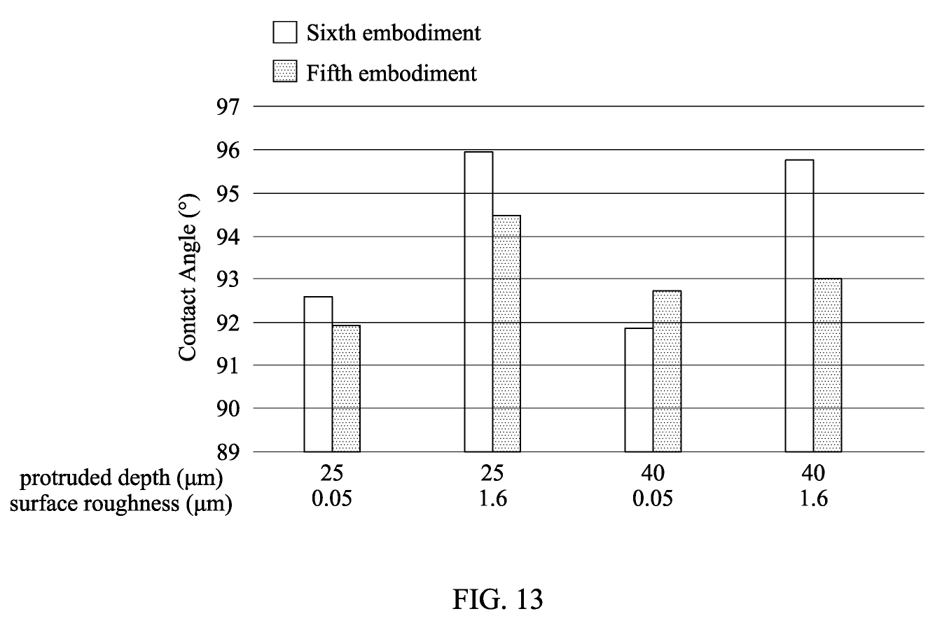

Referring to FIG. 13, FIG. 13 illustrates an experimental diagram of protruded depth, surface roughness, and contact angle for the fifth and sixth embodiments. From FIG. 13, it can be seen that the surface structure of the present disclosure exhibits a high contact angle under any protruded depth and surface roughness condition. Moreover, when the protruded depth was fixed at 25 µm or 40 µm and the surface roughness was increased, the contact angles of both the fifth and sixth embodiments were significantly enhanced. Among them, when the protruded depth of the fifth embodiment was 25 µm and the surface roughness was 1.6 µm, the fifth embodiment exhibited the largest contact angle of 96°.

The experimental results show that when the surface structure further includes a plurality of secondary structure layers disposed on one side of each protruded portion, and each secondary structure layer has a specific surface roughness, the surface structure exhibits a larger contact angle and improved hydrophobic properties.

### Surface Structure Morphology

In this experiment, the protruded depth of the first to third embodiments was set to 25 µm or 40 µm, and the surface structures of the first to third embodiments were placed under a microscope to observe their surface morphologies.

Referring to FIG. 14A, FIG. 14A is a microscope image of the first embodiment. When the protruded depth of the first embodiment was set to 25 µm, the protruded width of the surface structure was about 100 µm and the protruded length was about 150 µm.

Referring to FIG. 14B, FIG. 14B is another microscope image of the first embodiment. When the protruded depth of the first embodiment was set to 40 µm, the protruded width of the surface structure was about 80 µm and the protruded length was about 90 µm.

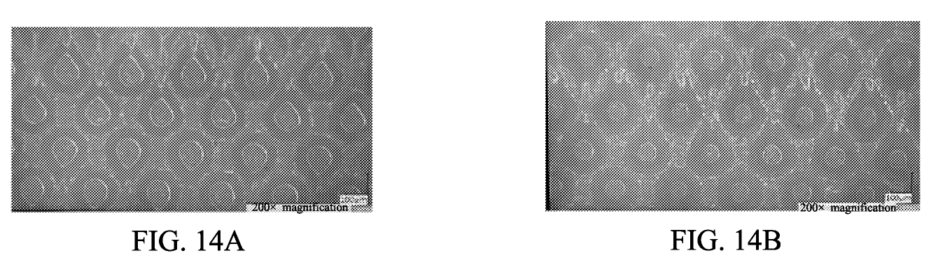

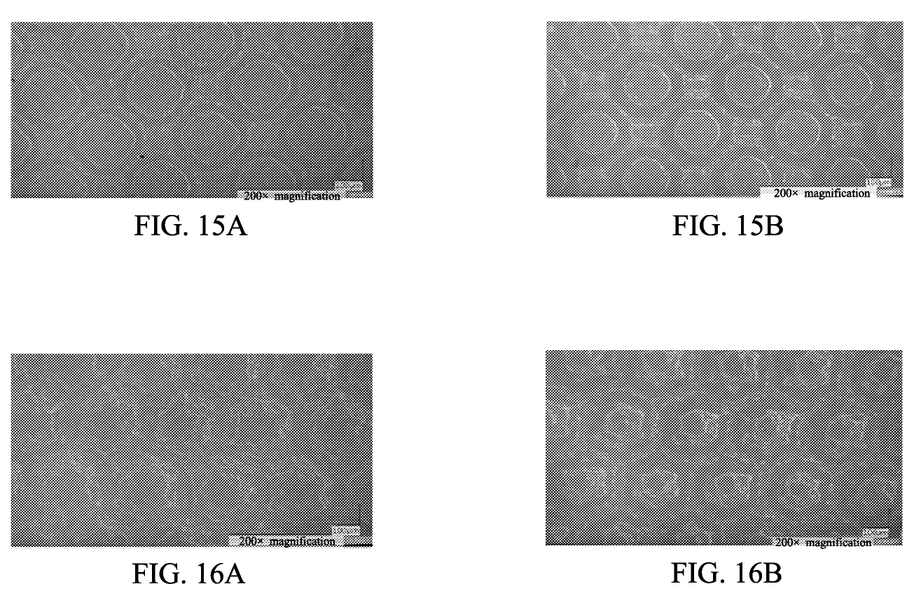

Referring to FIG. 15A, FIG. 15A is a microscope image of the second embodiment. When the protruded depth of the second embodiment was set to 25 µm, the protruded width of the surface structure was 260 µm.

Referring to FIG. 15B, FIG. 15B is another microscope image of the second embodiment. When the protruded depth of the second embodiment was set to 40 µm, the protruded width of the surface structure was 220 µm.

Referring to FIG. 16A, FIG. 16A is a microscope image of the third embodiment. When the protruded depth of the third embodiment was set to 25 µm, the protruded width of the surface structure was 250 µm and the protruded length was 300 µm.

Referring to FIG. 16B, FIG. 16B is another microscope image of the third embodiment. When the protruded depth of the third embodiment was set to 40 µm, the protruded width of the surface structure was 200 µm and the protruded length was 250 µm.

From the above microscope images, it can be observed that in the surface structure of the present disclosure, regardless of the cross-sectional shape of the protruded portions, complete morphology and proper dimensions can be achieved, and the arrangement can be well maintained. Therefore, the surface structure of the present disclosure can obtain favorable material properties.

In this experiment, the fifth and sixth embodiments were also tested. The surface roughness of the secondary structure layer was set to 0.05 µm or 1.6 µm, and the protruded depth was set to 25 µm or 40 µm. The surface structures of the fifth and sixth embodiments were placed under a microscope at 100× magnification to observe their surface morphologies.

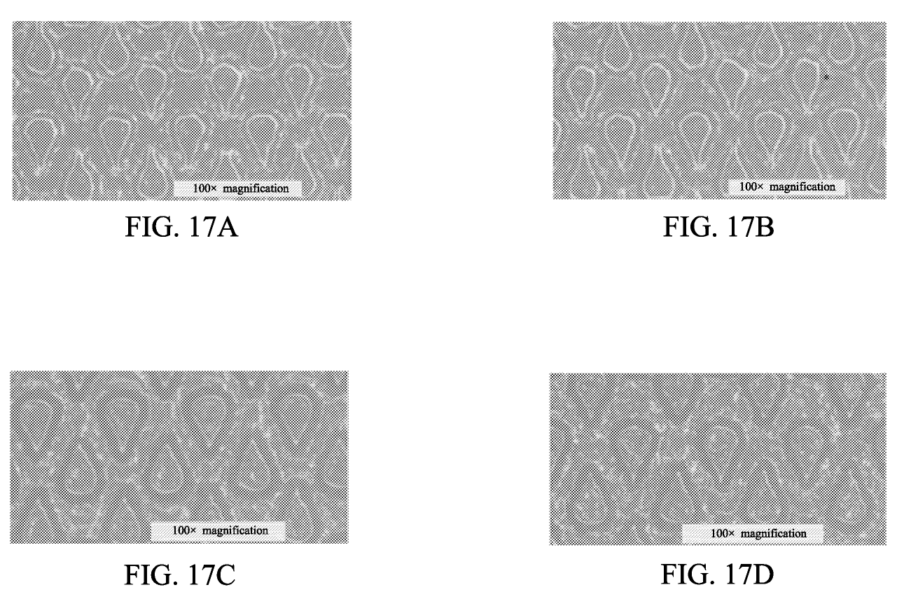

Referring to FIG. 17A, FIG. 17A is a microscope image of the fifth embodiment. When the protruded depth of the fifth embodiment was set to 25 µm and the surface roughness of the secondary structure layer was set to 0.05 µm, the actual appearance of the surface structure was as shown in FIG. 17A.

Referring to FIG. 17B, FIG. 17B is another microscope image of the fifth embodiment. When the protruded depth of the fifth embodiment was set to 25 µm and the surface roughness of the secondary structure layer was set to 1.6 µm, the actual appearance of the surface structure was as shown in FIG. 17B.

Referring to FIG. 17C, FIG. 17C is yet another microscope image of the fifth embodiment. When the protruded depth of the fifth embodiment was set to 40 µm and the surface roughness of the secondary structure layer was set to 0.05 µm, the actual appearance of the surface structure was as shown in FIG. 17C.

Referring to FIG. 17D, FIG. 17D is still another microscope image of the fifth embodiment. When the protruded depth of the fifth embodiment was set to 40 µm and the surface roughness of the secondary structure layer was set to 1.6 µm, the actual appearance of the surface structure was as shown in FIG. 17D.

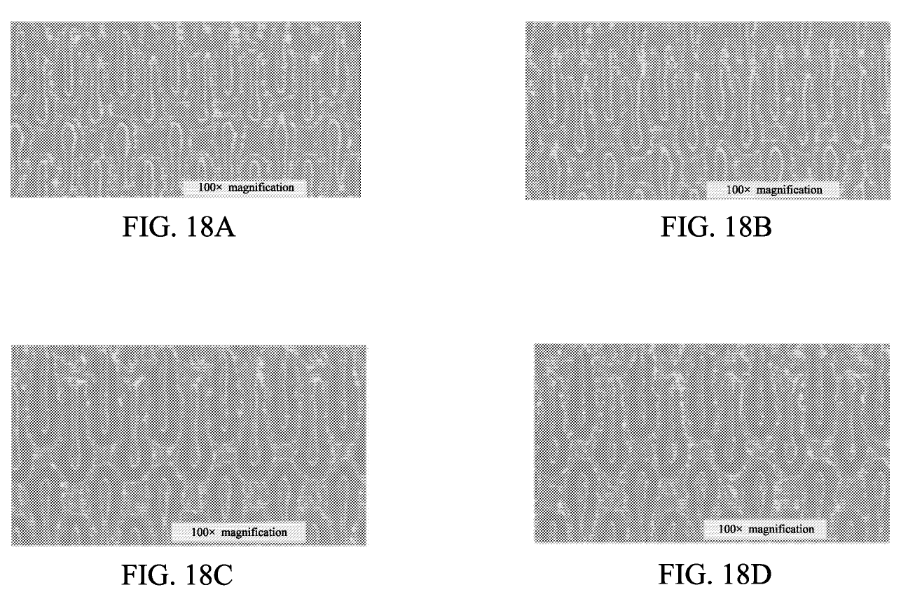

Referring to FIG. 18A, FIG. 18A is a microscope image of the sixth embodiment. When the protruded depth of the sixth embodiment was set to 25 µm and the surface roughness of the secondary structure layer was set to 0.05 µm, the actual appearance of the surface structure was as shown in FIG. 18A.

Referring to FIG. 18B, FIG. 18B is another microscope image of the sixth embodiment. When the protruded depth of the sixth embodiment was set to 25 µm and the surface roughness of the secondary structure layer was set to 1.6 µm, the actual appearance of the surface structure was as shown in FIG. 18B.

Referring to FIG. 18C, FIG. 18C is yet another microscope image of the sixth embodiment. When the protruded depth of the sixth embodiment was set to 40 µm and the surface roughness of the secondary structure layer was set to 0.05 µm, the actual appearance of the surface structure was as shown in FIG. 18C.

Referring to FIG. 18D, FIG. 18D is still another microscope image of the sixth embodiment. When the protruded depth of the sixth embodiment was set to 40 µm and the surface roughness of the secondary structure layer was set to 1.6 µm, the actual appearance of the surface structure was as shown in FIG. 18D.

From the above microscope images, it can be seen that in the surface structure of the present disclosure, regardless of the surface roughness of the secondary structure layers, both the primary structure layer and the secondary structure layers can exhibit complete morphology and appropriate dimensions, and can be well arranged. Therefore, the surface structure of the present disclosure can obtain favorable material properties.

### Experiment on Material and Contact Angle

In this experiment, different materials were selected, namely PC, ABS, ABS alloy with PC, and PC with added polysiloxane. Water droplets were dripped onto the surface structure to measure the contact angle.

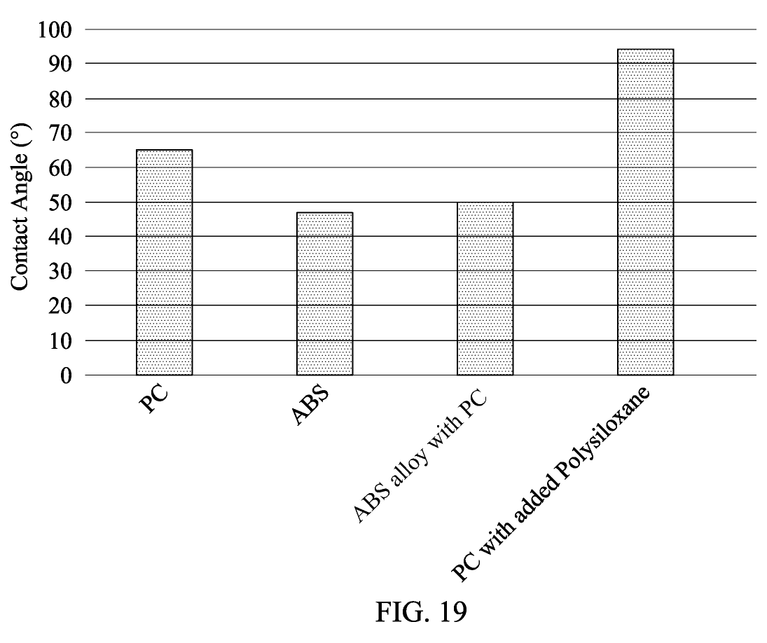

Referring to FIG. 19, FIG. 19 illustrates an experimental diagram of material versus contact angle of the surface structure. From FIG. 19, it can be seen that when the material is PC with added polysiloxane, the surface structure of the present disclosure has a contact angle greater than 90°. Due to the inherent chemical characteristics of the silicon-based molecular material, the more hydrophobic alkyl ends are oriented on the surface, thereby forming a hydrophobic layer on the surface structure and achieving improved hydrophobicity.

In summary, the surface structure of the present disclosure improves hydrophobicity and achieves a self-cleaning function by providing protruded portions and selecting the protruded width within a specific range. When liquid droplets fall onto the surface structure, the liquid is not easily attached to the surface, and dirt adhered to the surface can be carried away as the liquid slides off the surface structure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A surface structure, comprising:
a primary structure comprising a plurality of protruded portions, the protruded portions being located on one side of the primary structure and arranged apart from each other;
wherein each of the protruded portions has a protruded width ranging from 50 µm to 500 µm.

2. The surface structure according to claim 1, wherein a material of the surface structure is selected from a group consisting of polycarbonate, polyoxymethylene, acrylonitrile styrene acrylate, acrylonitrile butadiene styrene, polybutylene terephthalate, polymethyl methacrylate, and polysiloxane.

3. The surface structure according to claim 1, wherein a material of the surface structure is polycarbonate, polyoxymethylene, acrylonitrile styrene acrylate, acrylonitrile butadiene styrene, polybutylene terephthalate, polymethyl methacrylate, a mixture of polycarbonate and polysiloxane, a mixture of polycarbonate and acrylonitrile butadiene styrene, or a mixture of polycarbonate and acrylonitrile styrene acrylate.

4. The surface structure according to claim 1, wherein a cross-sectional shape of each of the protruded portions is circular, hexagonal, droplet-shaped, rectangular, or a combination thereof.

5. The surface structure according to claim 1, wherein a cross-sectional shape of each of the protruded portions is circular, and the protruded width is 120 µm to 350 µm.

6. The surface structure according to claim 1, wherein a cross-sectional shape of each of the protruded portions is hexagonal, each of the protruded portions has a protruded length ranging from 110 µm to 270 µm, and the protruded width is 140 µm to 240 µm.

7. The surface structure according to claim 1, wherein the protruded portions are arranged in a staggered manner.

8. The surface structure according to claim 1, wherein an interval length is provided between any two adjacent protruded portions, and the interval length is greater than or equal to 100 µm.

9. The surface structure according to claim 8, wherein the interval lengths between the protruded portions are unequal to each other.

10. The surface structure according to claim 1, further comprising:
a plurality of secondary structure layers respectively disposed on one side of each of the protruded portions, wherein a surface roughness of each of the secondary structure layers is less than or equal to 50 µm.

11. The surface structure according to claim 10, wherein the surface roughness ranges from 0.5 µm to 5.0 µm.

12. The surface structure according to claim 1, wherein each of the protruded portions has a protruded depth, and the protruded depth is greater than or equal to 15 µm.

13. The surface structure according to claim 12, wherein the protruded depth ranges from 25 µm to 50 µm.

14. The surface structure according to claim 12, wherein the protruded depths of the protruded portions are different from one another.

15. The surface structure according to claim 1, wherein a cross-sectional shape of each of the protruded portions is droplet-shaped, each of the protruded portions has a protruded length ranging from 120 µm to 370 µm, and the protruded width ranges from 150 µm to 310 µm.

16. The surface structure according to claim 15, wherein each of the protruded portions has a blunt end and a pointed end, and along an arrangement direction, the blunt end of each protruded portion is disposed opposite to the blunt end of one adjacent protruded portion, and the pointed end of each of the protruded portions is disposed opposite to the pointed end of another adjacent protruded portion.

17. The surface structure according to claim 15, wherein a ratio of the protruded width to the protruded length ranges from 1:1 to 1:6.

18. A mold for manufacturing the surface structure according to claim 1;
wherein the mold has a plurality of grooves arranged apart from each other, and each of the grooves has a groove width ranging from 50 µm to 500 µm.

19. A mold for manufacturing the surface structure according to claim 4;
wherein the mold has a plurality of grooves arranged apart from each other, and each of the grooves has a groove width ranging from 50 µm to 500 µm.

20. A mold for manufacturing the surface structure according to claim 15;
wherein the mold has a plurality of grooves arranged apart from each other, and each of the grooves has a groove width ranging from 50 µm to 500 µm.
